(19) United States
(12) Patent Application Publication
(10) Pub. No.: US 2006/0152893 A1
(43) Pub. Date: Jul. 13, 2006

(54) Portable information device having a lift function

(76) Inventor: Charlie Chen, Tao Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/033,635

(22) Filed: Jan. 13, 2005

(51) Int. Cl. G06F 1/16

(52) U.S. Cl. 361/681; 361/683

(57) ABSTRACT

A portable information device, such as a personal digital assistant or a notebook, having a lift function, has a mainframe, a monitor, a pivotal structure, and a guiding rod. The guiding rod has an end connected to the pivotal structure. The monitor is liftably connected to the other end of the guiding rod. The monitor can be lifted and adjusted to an appropriate height, so that the user can watch the monitor comfortably.

### BACKGROUND OF THE INVENTION

1. Field of the Invention

The present invention relates to a portable information device having a lift function, and more particularly, to a portable information device such as a personal digital assistant (PDA) or a notebook, wherein a monitor thereof is lifted and adjusted to a proper height, so that the user can view the monitor easily.

2. Background of the Invention

Personal digital assistants (PDA) and notebooks are common portable information devices. As personal digital assistants and notebooks become smaller and lighter, more and more people are starting to use them.

Most personal digital assistants and notebooks have a mainframe and a monitor. The mainframe and the monitor are pivotally connected with each other via a pivoting structure. The pivoting structure is as a fulcrum of the monitor, allowing the monitor to be opened or closed relative to the mainframe.

As the size of conventional portable information devices shrink increasingly smaller and smaller, the size of their monitors is also getting smaller. It is uncomfortable for a user bend their neck to lower their line of vision to view the monitor. If this must be done, after the user has viewed the monitor for a while, his neck will grow stiff and begin to ache.

In addition, the monitor of the conventional portable information device is fixed at a certain height. The height of the monitor cannot be adjusted, so it is unsuitable for different users.

Accordingly, as discussed above, the conventional portable information device still has some drawbacks that could be improved upon. The present invention aims to resolve the drawbacks in the prior art.

### SUMMARY OF INVENTION

The primary objective of the invention is therefore to specify a portable information device having a lift function, wherein a monitor thereof can be lifted and adjusted to a suitable height, so that the user can watch the monitor in comfortable.

Another objective of the invention is therefore to specify a portable information device having a lift function, wherein the height of the monitor thereof can be adjusted according to a user's height, so that the design of the portable information device is ergonomic and can be adjusted to various users' statures.

According to the invention, the objective is achieved via a portable information device having a lift function. The portable information device comprises a mainframe, a monitor, at least one pivotal structure, and at least one guiding rod. The at least one pivotal structure is fixed on the mainframe. The at least one guiding rod has an end and another end. The end of the at least one guiding rod is connected to the at least one pivotal structure, and the monitor is liftably connected to the another end of the at least one guiding rod.

To provide a further understanding of the invention, the following detailed description illustrates embodiments and examples of the invention. Examples of the more important features of the invention have thus been summarized rather broadly in order that the detailed description thereof that follows may be better understood, and in order that the contributions to the art may be appreciated. There are, of course, additional features of the invention which will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic perspective view of a first embodiment according to the present invention, wherein a monitor thereof is deployed at its lowest position;

FIG. 2 is a schematic perspective view of a first embodiment according to the present invention, wherein a monitor thereof is deployed at its highest position;

FIG. 3 is a schematic perspective view of a second embodiment according to the present invention, wherein a monitor thereof is deployed at its lowest position;

FIG. 4 is a schematic perspective view of a second embodiment according to the present invention, wherein a monitor thereof is deployed at its highest position;

FIG. 5 is a schematic perspective view of a third embodiment according to the present invention, wherein a monitor thereof is deployed at its lowest position;

FIG. 6 is a schematic perspective view of a third embodiment according to the present invention, wherein a monitor thereof is deployed at its highest position; and

FIG. 7 is a schematic perspective view of a fourth embodiment according to the present invention, wherein a monitor thereof is deployed at its highest position.

### DETAILED DESCRIPTION OF THE EMBODIMENTS

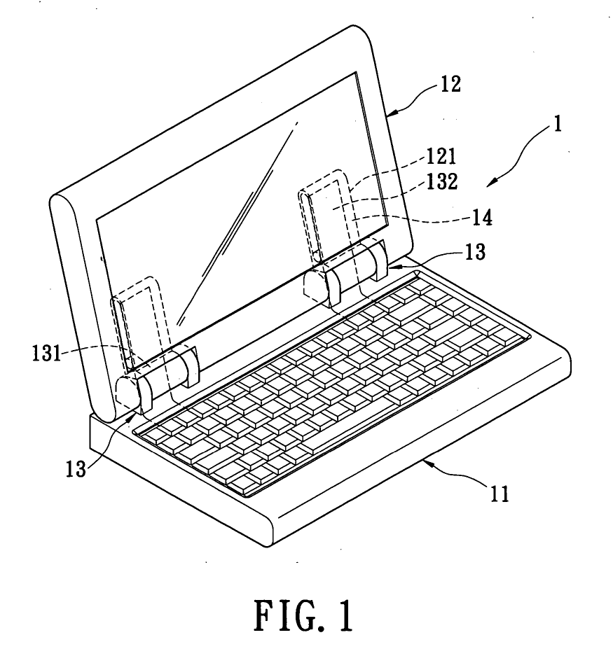

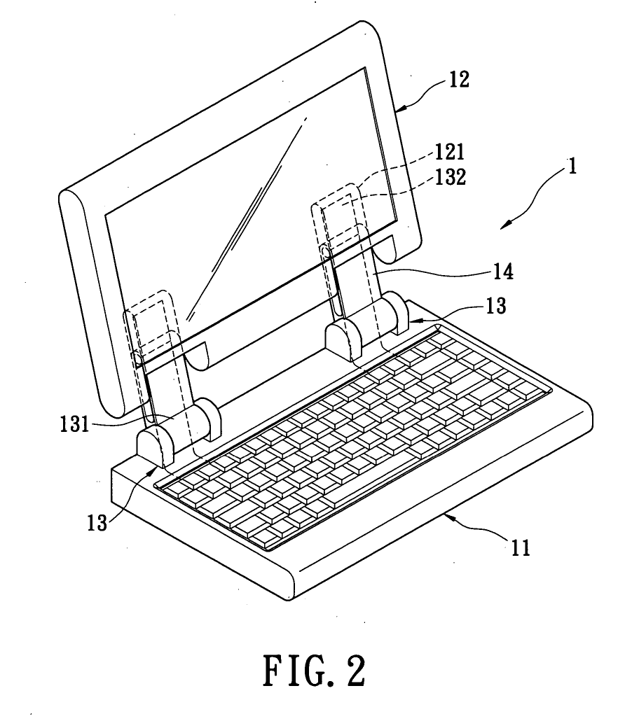

Referring to FIG. 1 and FIG. 2, the present invention provides a portable information device having a lift function. The portable information device can be a personal digital assistant, a notebook, and so on. The portable information device 1 comprises a mainframe 11, a monitor 12, and at least one pivotal structure 13. The mainframe 11 and the monitor 12 are pivotally connected to each other via the at least one pivotal structure 13. In this embodiment, there are two pivotal structures 13, and the mainframe 11 and the monitor 12 are pivotally connected to each other via the two pivotal structures 13. The two pivotal structures 13 are disposed between the mainframe 11, the monitor 12, near two sides of the mainframe 11 respectively and near two sides of the monitor 12 respectively. The two pivotal structures 13 act as a fulcrum of the monitor 12, so that the monitor 12 can be opened or closed relative to the mainframe 11.

The two pivotal structures 13 are fixed on the mainframe 11. Each of the two pivotal structures 13 has a connection portion 131 that is rotatable relative to the mainframe 11. The present invention comprises at least one guiding rod 14 with a proper length thereof. In this embodiment, there are two guiding rods 14. Each of the two guiding rods 14 has an end that is respectively connected to the connection portion 131 of each of the pivotal structures 13, so that the two guiding rods 14 rotate relative to the mainframe 11.

The monitor 12 has at least one guiding slot 121 disposed at a bottom thereof. In this embodiment, there are two guiding slots 121. The two guiding slots 121 correspond to the two guiding rods 14 and extend into the monitor 12 to an appropriate depth. The two guiding rods 14 are respectively and slidably inserted into the two guiding slots 121, so that the monitor 12 is liftably connected to the other end of each of the two guiding rods 14. The two guiding rods 14 guide the monitor 12 thereby lifting it. There is an appropriate tightness between the two guiding rods 14 and the two guiding slots 121, such that the monitor 12 is positioned at a proper height after it is lifted along the two guiding rods 14. The two guiding rods 14 can be hollow, so that a signal cable 132 electrically connecting the mainframe 11 and the monitor 12 can be disposed in either of the two guiding rods 14. The portable information device having a lift function of the present invention is formed according to the above assembly.

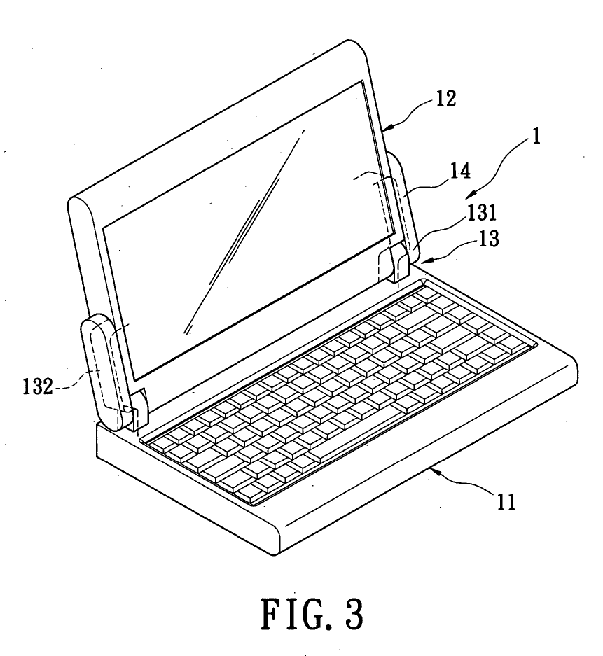

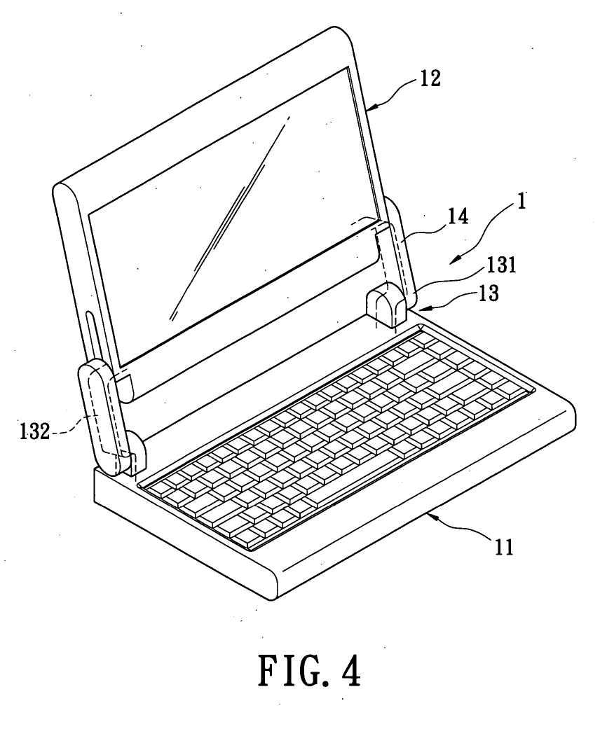

Referring to FIG. 3 and FIG. 4, in this embodiment, the mainframe 11 and the monitor 12 are connected with each other via two pivotal structures 13. The two pivotal structures 13 are disposed between the mainframe 11 and the monitor 12 and on two sides of the mainframe 11 respectively and on two sides of the monitor 12 respectively. The monitor 12 has two sides slidably adapted to the two guiding rods 14, so that the two guiding rods 14 guide the monitor 12 to be lifted.

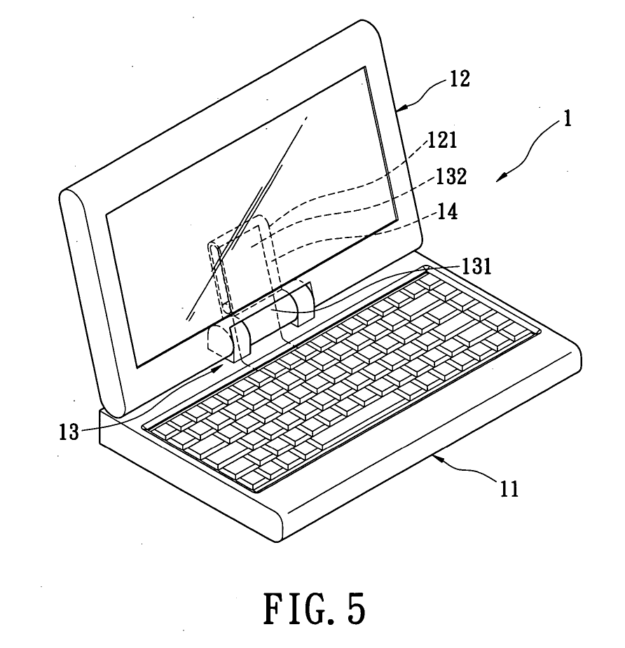

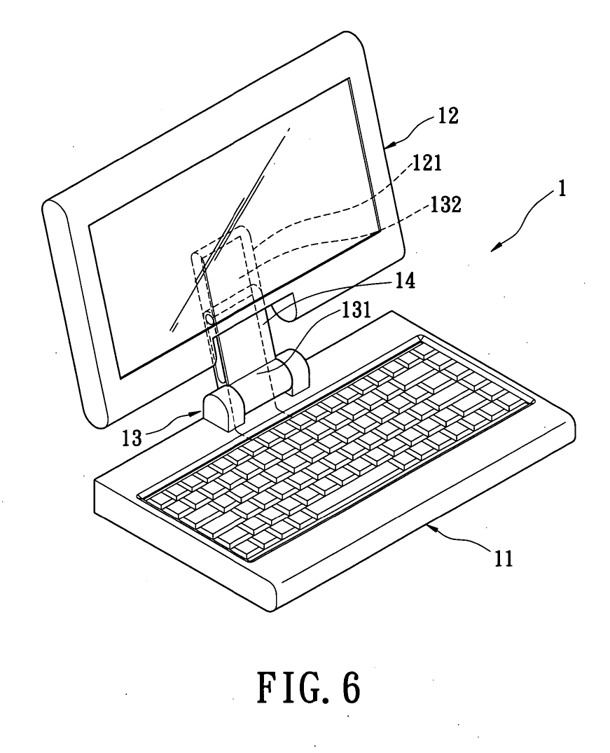

Referring to FIG. 5 and FIG. 6, in this embodiment, the mainframe 11 and the monitor 12 are connected with each other via one pivotal structure 13. The pivotal structure 13 is disposed between the mainframe 11 and the monitor 12 and at a middle of the mainframe 11 and at a middle of the monitor 12. The connection portion 131 of the pivotal structure 13 connects one guiding rod 14, and the monitor 12 has one guiding slot 121 disposed in a middle of a bottom thereof and being relative to the guiding rod 14. The guiding rod 14 is slidably inserted into the guiding slot 121, so that the guiding rod 14 guides the monitor 12 thereby lifting it.

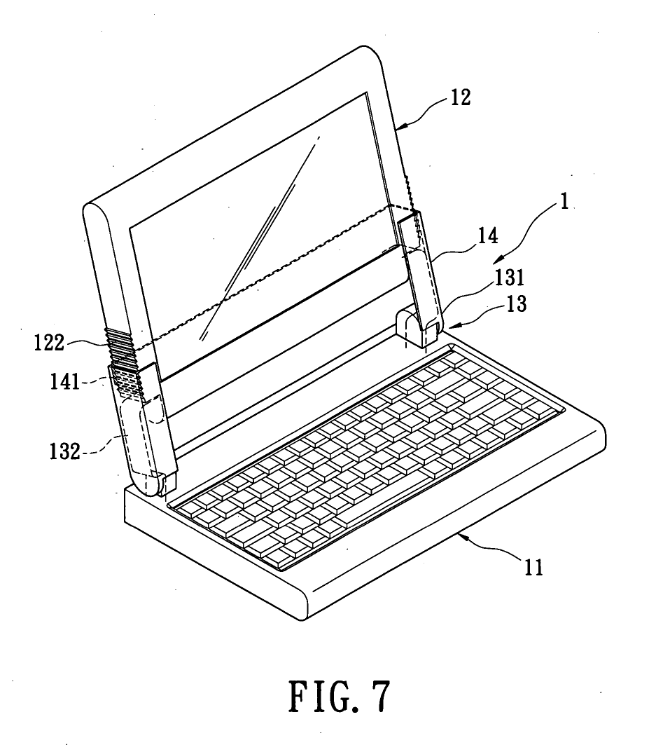

Referring to FIG. 7, in this embodiment, the mainframe 11 and the monitor 12 are connected with each other via two pivotal structures 13. The two pivotal structures 13 are disposed between the mainframe 11 and the monitor 12 and at two sides of the mainframe 11 respectively and at two sides of the monitor 12 respectively. The monitor 12 has two sides slidably adapted to the two guiding rods 14, so that the two guiding rods 14 guide the monitor 12 thereby lifting it. The monitor 12 has toothed positioning portions 122 disposed at the two sides thereof. Each of the two guiding rods 14 has toothed positioning portions 141 disposed at an inside thereof. The positioning portions 122 of the monitor 12 engage with the positioning portions 141 of the two guiding rods 14, such that the monitor 12 is positioned at a proper height after it is lifted along the two guiding rods 14.

The monitor 12 of the portable information device of the present invention can be positioned according to the user. After the monitor 12 is lifted, the user does not have to bend his or her neck to lower their line of vision to view the monitor 12. Therefore, the user can view the monitor 12 comfortably.

Furthermore, the portable information device of the present invention has a lift function, so that the monitor 12 is lifted and adjusted according to the user's height, so that the design of the portable information device is ergonomic and can be adjusted to various users' statures.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A portable information device having a lift function, comprising:
a mainframe;
a monitor;
at least one pivotal structure fixed on the mainframe; and
at least one guiding rod having an end and another end, the end of the at least one guiding rod being connected to the at least one pivotal structure, and the monitor being liftably connected to the other end of the at least one guiding rod.

2. The portable information device as claimed in claim 1, wherein the monitor has at least one guiding slot disposed at a bottom thereof, the at least one guiding slot corresponds to the at least one guiding rod and extends into the monitor, and the at least one guiding rod is slidably inserted into the at least one guiding slot.

3. The portable information device as claimed in claim 1, wherein the monitor has two sides slidably adapted to the at least one guiding rod.

4. The portable information device as claimed in claim 1, wherein the at least one pivotal structure has a connection portion that is rotatable relative to the mainframe, and the at least one guiding rod is connected to the connection portion.

5. The portable information device as claimed in claim 1, wherein there are two pivotal structures, and the two pivotal structures are disposed between the mainframe and the monitor and near two sides of the mainframe respectively and near two sides of the monitor respectively.

6. The portable information device as claimed in claim 1, wherein there are two pivotal structures, and the two pivotal structures are disposed between the mainframe and the monitor and at two sides of the mainframe respectively and at two sides of the monitor respectively.

7. The portable information device as claimed in claim 1, wherein there is at least one pivotal structure, and the pivotal structure is disposed between the mainframe and the monitor and at a middle of the mainframe and at a middle of the monitor.

8. The portable information device as claimed in claim 1, wherein the at least one guiding rod is hollow, the mainframe and the monitor electrically connect with each other via a signal cable, and the signal cable is disposed in the at least one guiding rod.

9. The portable information device as claimed in claim 1, wherein the monitor has positioning portions, the at least one guiding rod has positioning portions, and the positioning portions of the monitor engage with the positioning portions of the at least one guiding rod.
